(19) United States
(12) Patent Application Publication
(10) Pub. No.: US 2023/0334284 A1
(43) Pub. Date: Oct. 19, 2023

(54) SPARSIFYING VECTORS FOR NEURAL NETWORK MODELS BASED ON OVERLAPPING WINDOWS

(71) Applicant: Microsoft Technology Licensing, LLC, Redmond, WA (US)

(72) Inventors: Girish Vishnu VARATKAR, Sammamish, WA (US); Ankit MORE, San Mateo, CA (US); Bita DARVISH ROUHANI, Bellevue, WA (US); Mattheus C. HEDDES, Redmond, WA (US); Gaurav AGRAWAL, San Jose, CA (US)

(21) Appl. No.: 17/827,222

(22) Filed: May 27, 2022

Related U.S. Application Data
(60) Provisional application No. 63/331,188, filed on Apr. 14, 2022.

(51) Int. Cl. G06N 3/04; G06K 9/62

(52) U.S. Cl. CPC G06N 3/04; G06K 9/6228

(57) ABSTRACT

Embodiments of the present disclosure include systems and methods for sparsifying vectors for neural network models based on overlapping windows. A window is used to select a first set of elements in a vector of elements. A first element is selected from the first set of elements having the highest absolute value. The window is slid along the vector by a defined number of elements. The window is used to select a second set of elements in the vector, wherein the first set of elements and the second set of elements share at least one common element. A second element is selected from the second set of elements having the highest absolute value.

### CROSS REFERENCE TO RELATED APPLICATIONS

The present application claims the benefit and priority of U.S. Provisional Application No. 63/331,188, filed Apr. 14, 2022, entitled “Overlapped Window Sparsity Pattern Selection,” the entire contents of which are incorporated herein by reference in its entirety for all purposes.

### BACKGROUND

The present disclosure relates to computing hardware. More particularly, the present disclosure relates to techniques for sparsifying neural network parameters and/or activations.

A neural network is a machine learning model used for a variety of different applications (e.g., image classification, computer vision, natural language processing, speech recognition, writing recognition, etc.). A neural network may be trained for a particular purpose by running datasets through it, comparing results from the neural network to known results, and updating the network based on the differences.

### BRIEF DESCRIPTION OF THE DRAWINGS

Various embodiments of the present disclosure are illustrated by way of example and not limitation in the figures of the accompanying drawings.

FIG. 1 illustrates an example neural network model according to some embodiments.

FIGS. 2A-2E illustrate an example of sparsifying a vector according to some embodiments.

FIG. 3 illustrates a process for sparsifying a vector according to some embodiments.

FIG. 4 depicts a simplified block diagram of an example computer system according to some embodiments.

FIG. 5 illustrates a neural network processing system according to some embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Described here are techniques for sparsifying vectors for neural network models based on overlapping windows. In some embodiments, a neural network model includes numerous parameters arranged in the form of vectors and/or matrices. These vectors and/or matrices can be sparsified using an overlapping window technique. For example, a neural network model can include vectors of weight values and vectors of activation values. To sparsify any one (or both) of these vectors, a window having a defined length is used to select a subset of elements in the vector. Next, the element having the highest absolute value is selected from the selected subset of elements. The window is slid across the vector by a defined number of elements. Then, the process is repeated (e.g., selecting a subset of elements in the vector, selecting the element having the highest absolute value from the selected subset of elements, and sliding the window across the vector) until the window has moved across the entire vector. Elements that are not selected are modified to a defined value (e.g., zero).

The techniques described in the present application provide a number of benefits and advantages over conventional methods of sparsifying neural network parameters. First, a vector sparsification technique that uses an overlapping window to select non-zero elements from the vector may be implemented using less resources (e.g., computing hardware, memory, etc.) compared to conventional vector sparsification approaches that have similar levels of accuracy. Second, for a given amount of hardware, vector sparsification techniques based on overlapping windows provide better accuracy than conventional vector sparsification approaches implemented on the same given amount of hardware.

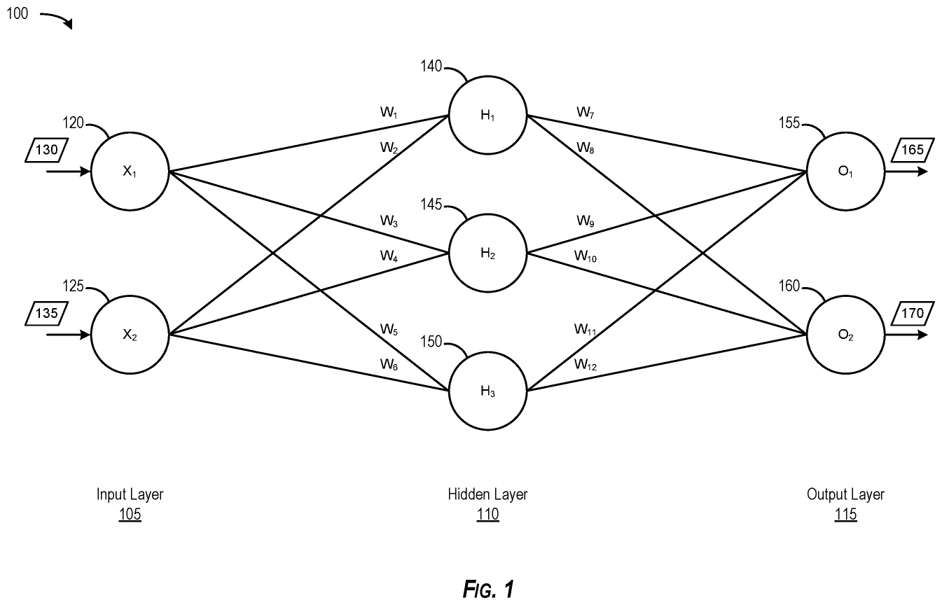

FIG. 1 illustrates an example neural network model 100 according to some embodiments. As shown, neural network model 100 includes input layer 105, hidden layer 110, and outer layer 115. Input layer 105 includes two nodes 120 and 125. Each of the nodes 120 and 125 is configured to receive input data and send the input data to each of the nodes in hidden layer 110. For this example, node 120 receives input data 130 and sends it to each of the nodes 140-150. Node 125 receives input data 135 and sends it to each of the nodes 140-150.

As depicted in FIG. 1, hidden layer 110 includes three nodes 140-150. Each of the nodes 140-150 receives data from each of the nodes 120 and 125 comprised of a particular weight value multiplied to a value of a corresponding input data. In this example, node 140 receives data comprised of input data 130 multiplied by weight value W₁ and input data 135 multiplied by weight value W₂. Similarly, node 145 receives data comprised of input data 130 multiplied by weight value W₃ and input data 135 multiplied by weight value W₄. Node 150 receives data comprised of input data 130 multiplied by weight value W₅ and input data 135 multiplied by weight value W₆. Each of the nodes 140-150 is configured to apply an activation function to the sum of the received inputs and, based on the activation function, generates an output that is sent to each of the nodes 155 and 160.

As illustrated, outer layer 115 includes nodes 155 and 160. Each of the nodes 155 and 160 receives data from each of the nodes 140-150 comprised of a particular weight value multiplied to a value of a corresponding output generated by one of the corresponding nodes 140-150. Here, node 155 receives data comprised of the output generated by node 140 multiplied by weight value W₇, the output generated by node 145 multiplied by weight value W₉, and the output generated by node 150 multiplied by weight value W₁₁. Similarly, node 160 receives data comprised of the output generated by node 140 multiplied by weight value W₈, the output generated by node 145 multiplied by weight value W₁₀, and the output generated by node 150 multiplied by weight value W₁₂. Each of the nodes 155 and 160 applies an activation function to the sum of the received inputs and, based on the activation function, generates an output. As shown, node 155 generates output 165 based on the sum of its received inputs while node 160 generates output 170 based on the sum of its received inputs.

In some embodiments, the calculations in neural network model 100 can be implemented using vectors of values. Specifically, the inputs for nodes 140-150 may be generated by multiplying a vector of input data 130 and 135 by a vector of weight values W₁-W₆. In addition, the inputs for nodes 155 and 160 can be generated by multiplying a vector of the activation function outputs generated by nodes 140-150 by a vector of weight values W₇-W₁₂. In some embodiments, the sparsification techniques described herein may be applied to one of the vectors of weight values, the vector of activation outputs, each of the vectors of weights values and the vector of activation outputs, or any combination thereof.

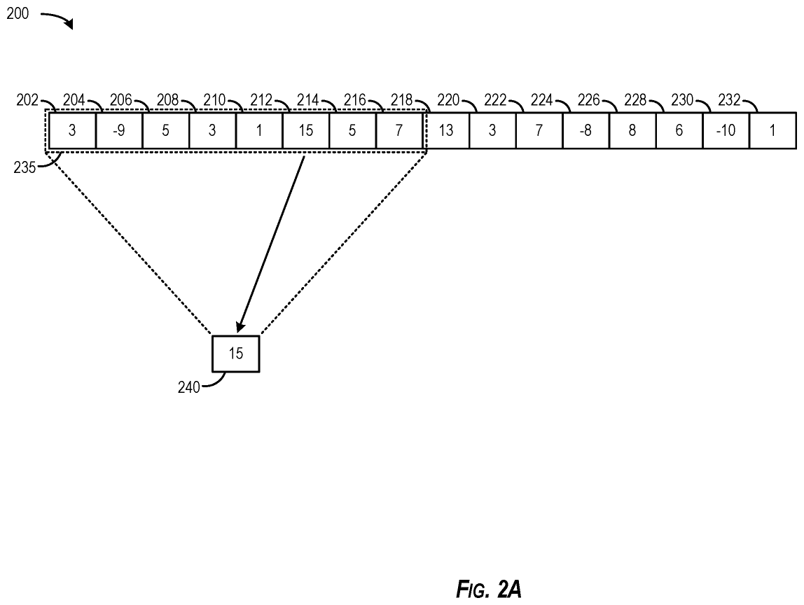

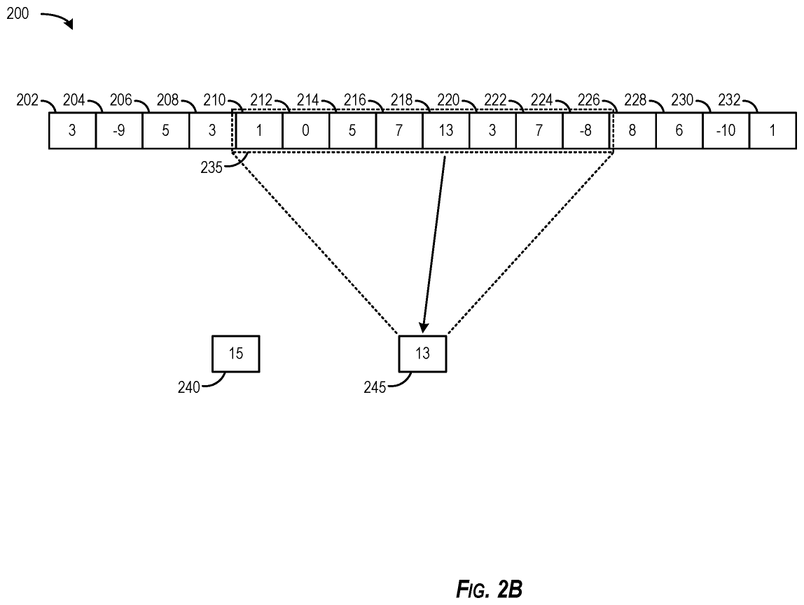

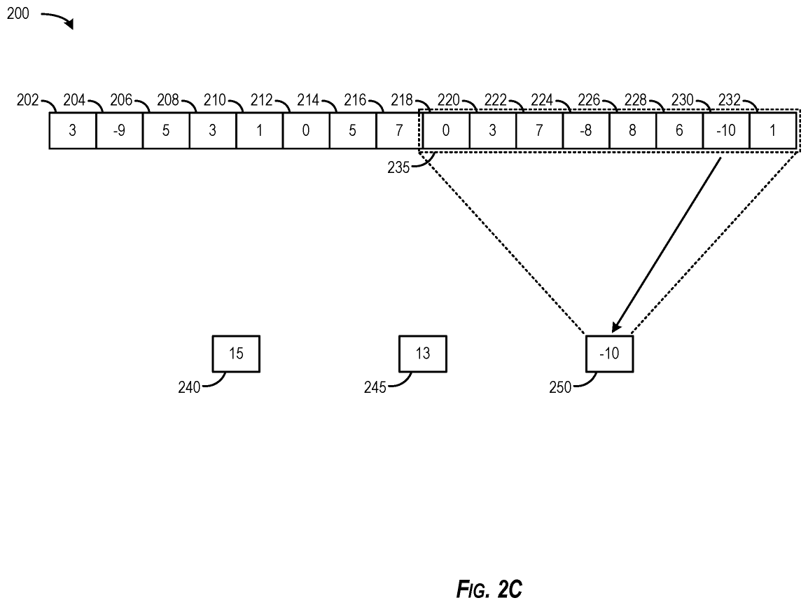

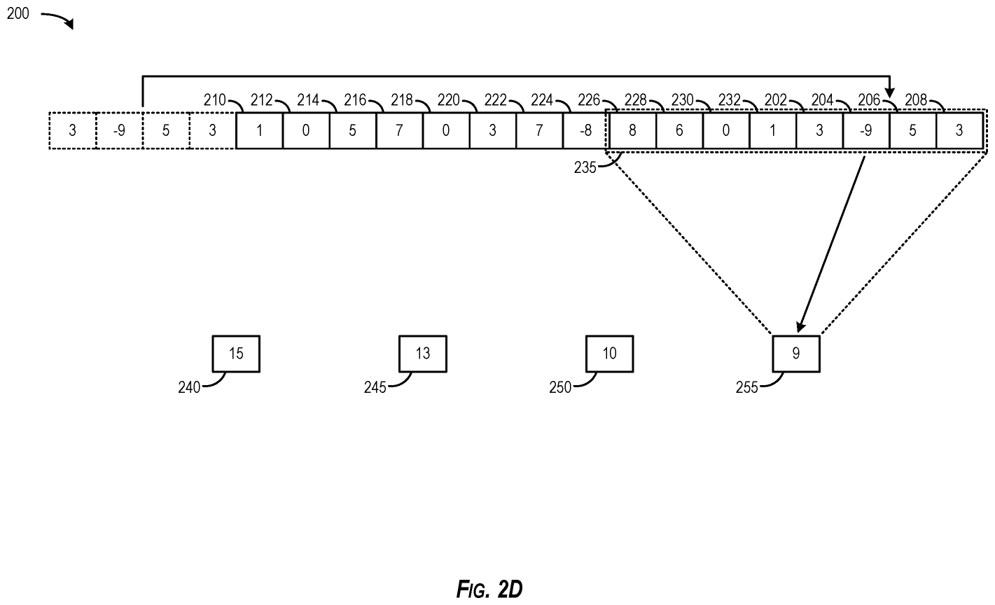

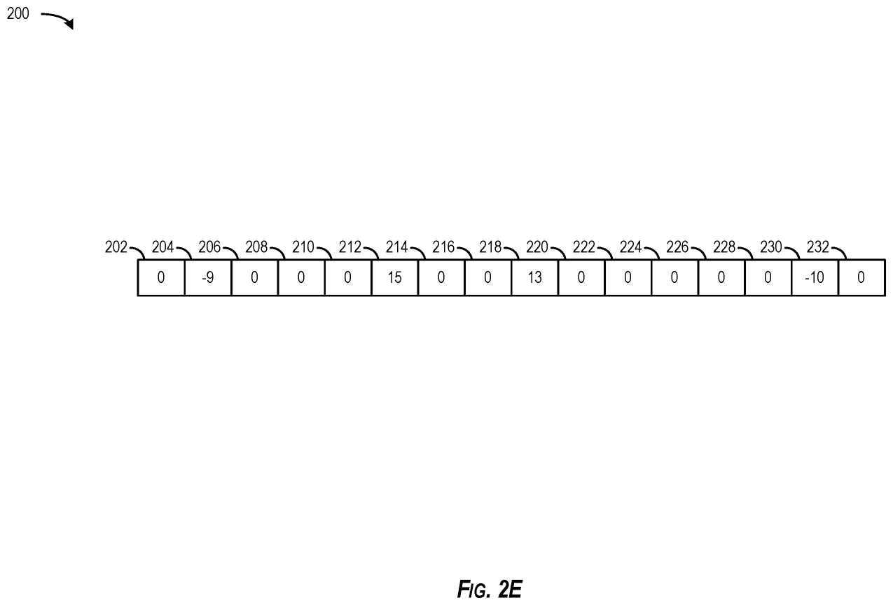

FIGS. 2A-2E illustrate an example of sparsifying a vector 200 according to some embodiments. In particular, the example demonstrates how vector 200 is sparsified using an overlapping window approach. As illustrated in FIG. 2A, vector 200 includes sixteen elements 202-232. Each of the elements 202-232 stores a particular value. For this example, vector 200 will be sparsified to a 75% level. That is, four elements with non-zero values will be selected from vector 200 and any unselected elements in vector 200 will be modified to a defined value (e.g., zero). The example starts by using a window 235 having a defined length (a window of eight elements in this example) to select the first eight elements 202-216 in vector 200. From the elements selected by window 235, the element having the highest absolute value is selected and stored in a storage 240. As depicted, element 212 has the highest absolute value among all the elements in window 235. As such, element 212 is selected and stored in storage 240.

Referring now to FIG. 2B, the value of the selected element 212 is changed to a defined value. Here, the defined value is zero (“0”). Then, window 235 is slid across vector 200 by a defined number of elements and a new set of elements are selected using window 235. In this example, the defined number of elements is four. As shown in FIG. 2B, window 235 is slid across vector 200 by four elements and elements 210-224 are now selected by window 235. Next, the element having the highest absolute value is selected from the elements selected by window 235 and stored in a storage 245. As illustrated in FIG. 2B, element 218 has the highest absolute value among all the elements in window 235. Therefore, element 218 is selected and stored in storage 245.

Referring now to FIG. 2C, the value of the selected element 218 is modified to the defined value. As depicted, the value of element 218 has been modified to zero. Window 235 is then slid across vector 200 by the defined number of elements and a new set of elements are selected using window 235. As illustrated in FIG. 2C, window 235 is slid across vector 200 by four elements and elements 218-232 are now selected by window 235. The element having the highest absolute value is selected from the elements selected by window 235 and stored in a storage 250. Here, element 230 has the highest absolute value among all the elements in window 235, as depicted in FIG. 2C. Hence, element 230 is selected and stored in storage 250.

Referring now to FIG. 2D, the value of the selected element 230 is changed to the defined value. Next, window 235 is slid across vector 200 by the defined number of elements and a new set of elements are selected using window 235. At this step, window 235 extends past the end of vector 200 and only elements 226-232 are selected by window 235. To fill in the remaining elements in window 235, the first four elements in vector 200 are used to fill in the missing elements in window 235. As shown in FIG. 2D, window 235 is slid across vector 200 by four elements, the first four elements 202-208 are filled in the last four elements of window 235. As such, elements 226-232 and 202-208 are now selected by window 235. Then, the element having the highest absolute value is selected from the elements selected by window 235 and stored in a storage 255. As illustrated in FIG. 2D, element 204 has the highest absolute value among all the elements in window 235. Thus, element 204 is selected and stored in storage 255.

FIG. 2E illustrates vector 200 after it has been sparsified using the technique explained above. As shown, the values of elements 204, 212, 218, and 230, which were the elements selected at each stage shown in FIGS. 2A-2D, are still stored in vector 200. The values of the unselected elements 202, 206-210, 214, 216, 220-228, and 232 have been modified to a defined sparsity value (zero in this example).

In some embodiments, the sparsification technique described above by reference to FIGS. 2A-2E may be implemented in hardware using multiplexers as well as other components necessary to accomplish the intended functionality described above. While the vector used in this example includes a certain number of elements and, one of ordinary skill in the art will understand that the techniques shown in this example may be applied to sparsify vectors having any number of different elements. Moreover, one of ordinary skill in the art will appreciate that windows having different lengths can be used in different embodiments.

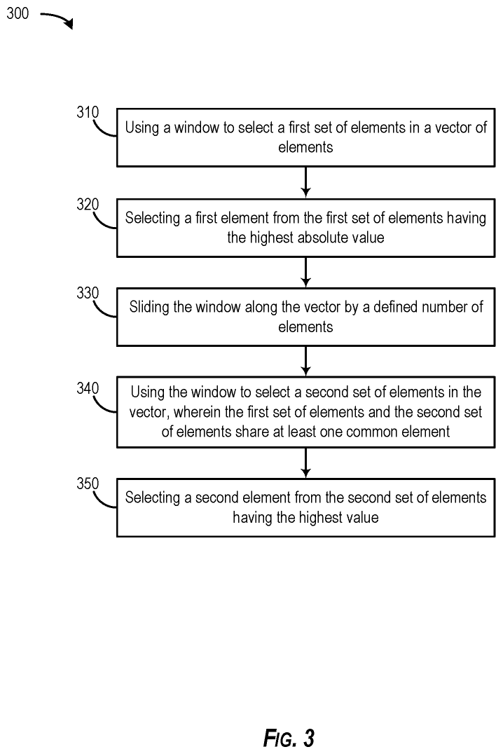

FIG. 3 illustrates a process 300 for sparsifying a vector according to some embodiments. In some embodiments, a computing device (e.g., computer system 400) or artificial intelligence (AI) hardware (e.g., a neural network processor 511) performs process 300. Process 300 begins by using, at 310, a window to select a first set of elements in a vector of elements. Referring to FIG. 2A as an example, window 235 is used to select the set of elements 202-216.

Next, process 300 selects, at 320, a first element from the first set of elements having the highest absolute value. Referring to FIG. 2A as an example, element 212 is selected from the set of elements 202-216 because it is the element having the highest absolute value. Process 300 then slides, at 330, the window along the vector by a defined number of elements. Referring to FIGS. 2A and 2B as an example, window 235 in FIG. 2A is slid along vector 200 by four elements to the position shown in FIG. 2B.

At 340, process 300 uses the window to select a second set of elements in the vector, wherein the first set of elements and the second set of elements share at least one common element. Referring to FIG. 2B as an example, window 235 is used to select the set of elements 210-224. Finally, process 300 selects, at 350, a second element from the second set of elements having the highest absolute value. Referring to FIG. 2B as an example, element 218 is selected from the set of elements 210-224 as it is the element having the highest absolute value.

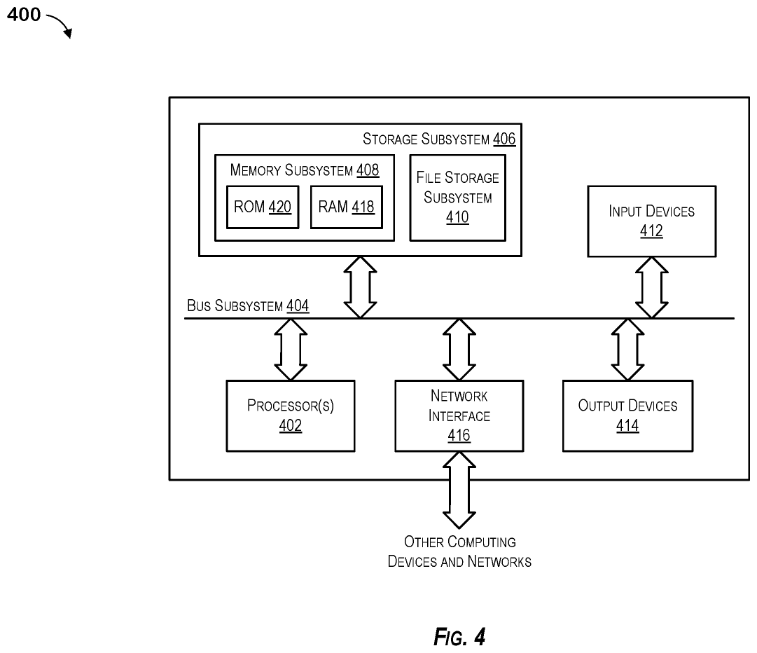

The techniques describe above may be implemented in a wide range of computer systems configured to process neural networks. FIG. 4 depicts a simplified block diagram of an example computer system 400, which can be used to implement the techniques described in the foregoing disclosure. As shown in FIG. 4, computer system 400 includes one or more processors 402 that communicate with a number of peripheral devices via a bus subsystem 404. These peripheral devices may include a storage subsystem 406 (e.g., comprising a memory subsystem 408 and a file storage subsystem 410) and a network interface subsystem 416. Some computer systems may further include user interface input devices 412 and/or user interface output devices 414.

Bus subsystem 404 can provide a mechanism for letting the various components and subsystems of computer system 400 communicate with each other as intended. Although bus subsystem 404 is shown schematically as a single bus, alternative embodiments of the bus subsystem can utilize multiple busses.

Network interface subsystem 416 can serve as an interface for communicating data between computer system 400 and other computer systems or networks. Embodiments of network interface subsystem 416 can include, e.g., Ethernet, a Wi-Fi and/or cellular adapter, a modem (telephone, satellite, cable, ISDN, etc.), digital subscriber line (DSL) units, and/or the like.

Storage subsystem 406 includes a memory subsystem 408 and a file/disk storage subsystem 410. Subsystems 408 and 410 as well as other memories described herein are examples of non-transitory computer-readable storage media that can store executable program code and/or data that provide the functionality of embodiments of the present disclosure.

Memory subsystem 408 includes a number of memories including a main random access memory (RAM) 418 for storage of instructions and data during program execution and a read-only memory (ROM) 420 in which fixed instructions are stored. File storage subsystem 410 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 400 is illustrative and many other configurations having more or fewer components than system 400 are possible.

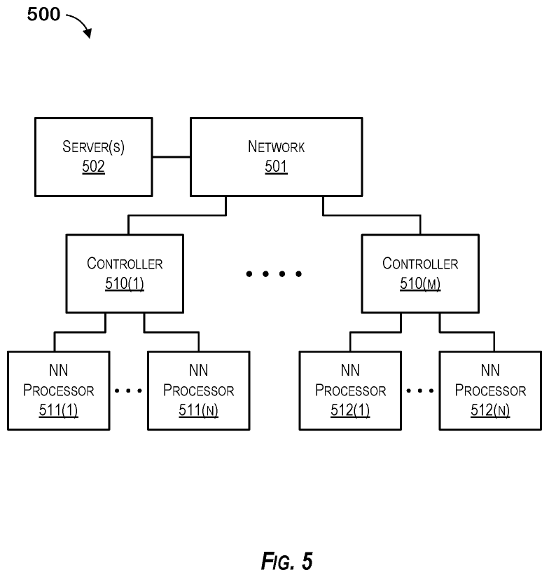

FIG. 5 illustrates a neural network processing system 500 according to some embodiments. In various embodiments, neural networks according to the present disclosure may be implemented and trained in a hardware environment comprising one or more neural network processors. A neural network processor may refer to various graphics processing units (GPU) (e.g., a GPU for processing neural networks produced by Nvidia Corp®), field programmable gate arrays (FPGA) (e.g., FPGAs for processing neural networks produced by Xilinx®), or a variety of application specific integrated circuits (ASICs) or neural network processors comprising hardware architectures optimized for neural network computations, for example. In this example environment, one or more servers 502, which may comprise architectures illustrated in FIG. 4 above, may be coupled to a plurality of controllers 510(1)-510(M) over a communication network 501 (e.g., switches, routers, etc.). Controllers 510(1)-510(M) may also comprise architectures illustrated in FIG. 4 above. Each controller 510(1)-510(M) may be coupled to one or more NN processors, such as processors 511(1)-511(N) and 512(1)-512(N), for example. In some embodiments, NN processors 511(1)-511(N) and 512(1)-512(N) may be used to implement AI processor(s) 135. NN processors 511(1)-511(N) and 512(1)-512(N) may include a variety of configurations of functional processing blocks and memory optimized for neural network processing, such as training or inference. The NN processors are optimized for neural network computations. Server 502 may configure controllers 510 with NN models as well as input data to the models, which may be loaded and executed by NN processors 511(1)-511(N) and 512(1)-512(N) in parallel, for example. Models may include layers and associated weights as described above, for example. NN processors may load the models and apply the inputs to produce output results. NN processors may also implement training algorithms described herein, for example.

### Further Example Embodiments

In various embodiments, the present disclosure includes systems, methods, and apparatuses for sparsifying vectors for neural network models based on overlapping windows. The techniques described herein may be embodied in non-transitory machine-readable medium storing a program executable by a computer system, the program comprising sets of instructions for performing the techniques described herein. In some embodiments, a system includes a set of processing units and a non-transitory machine-readable medium storing instructions that when executed by at least one processing unit in the set of processing units cause the at least one processing unit to perform the techniques described above. In some embodiments, the non-transitory machine-readable medium may be memory, for example, which may be coupled to one or more controllers or one or more artificial intelligence processors, for example.

The following techniques may be embodied alone or in different combinations and may further be embodied with other techniques described herein.

For example, in one embodiment, the present disclosure includes a non-transitory machine-readable medium storing a program executable by at least one processing unit of a device, the program comprising sets of instructions for using a window to select a first set of elements in a vector of elements; selecting a first element from the first set of elements having the highest absolute value; sliding the window along the vector by a defined number of elements; using the window to select a second set of elements in the vector, wherein the first set of elements and the second set of elements share at least one common element; and selecting a second element from the second set of elements having the highest absolute value.

In one embodiment, the vector is a first vector, wherein the program further comprises a set of instructions for multiplying the selected first and second elements in the vector with corresponding first and second elements in a second vector of elements.

In one embodiment, the first and second vectors are parameters in a neural network model.

In one embodiment, the first element in the first set of elements is included in the second set of elements, wherein selecting the second element from the second set of elements comprises selecting an element other than the first element from the second set of elements having the highest absolute value.

In one embodiment, the program further comprises a set of instructions for, after selecting the first element from the first set of elements and before selecting the second element from the second set of elements, storing the first element and modifying the value of the first element in the vector to a defined value.

In one embodiment, the second set of elements comprises a third set of elements from a first end of the vector and a fourth set of elements from a second end of the vector.

In one embodiment, the first element and the second element are different elements in the vector.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A non-transitory machine-readable medium storing a program executable by at least one processing unit of a device, the program comprising sets of instructions for:
using a window to select a first set of elements in a vector of elements;
selecting a first element from the first set of elements having the highest absolute value;
sliding the window along the vector by a defined number of elements;
using the window to select a second set of elements in the vector, wherein the first set of elements and the second set of elements share at least one common element; and
selecting a second element from the second set of elements having the highest absolute value.

2. The non-transitory machine-readable medium of claim 1, wherein the vector is a first vector, wherein the program further comprises a set of instructions for multiplying the selected first and second elements in the vector with corresponding first and second elements in a second vector of elements.

3. The non-transitory machine-readable medium of claim 2, wherein the first and second vectors are parameters in a neural network model.

4. The non-transitory machine-readable medium of claim 1, wherein the first element in the first set of elements is included in the second set of elements, wherein selecting the second element from the second set of elements comprises selecting an element other than the first element from the second set of elements having the highest absolute value.

5. The non-transitory machine-readable medium of claim 1, wherein the program further comprises a set of instructions for, after selecting the first element from the first set of elements and before selecting the second element from the second set of elements, storing the first element and modifying the value of the first element in the vector to a defined value.

6. The non-transitory machine-readable medium of claim 1, wherein the second set of elements comprises a third set of elements from a first end of the vector and a fourth set of elements from a second end of the vector.

7. The non-transitory machine-readable medium of claim 1, wherein the first element and the second element are different elements in the vector.

8. A method comprising:
using a window to select a first set of elements in a vector of elements;
selecting a first element from the first set of elements having the highest absolute value;
sliding the window along the vector by a defined number of elements;
using the window to select a second set of elements in the vector, wherein the first set of elements and the second set of elements share at least one common element; and
selecting a second element from the second set of elements having the highest absolute value.

9. The method of claim 8, wherein the vector is a first vector, the method further comprising multiplying the selected first and second elements in the vector with corresponding first and second elements in a second vector of elements.

10. The method of claim 9, wherein the first and second vectors are parameters in a neural network model.

11. The method of claim 8, wherein the first element in the first set of elements is included in the second set of elements, wherein selecting the second element from the second set of elements comprises selecting an element other than the first element from the second set of elements having the highest absolute value.

12. The method of claim 8, wherein the program further comprises a set of instructions for, after selecting the first element from the first set of elements and before selecting the second element from the second set of elements, storing the first element and modifying the value of the first element in the vector to a defined value.

13. The method of claim 8, wherein the second set of elements comprises a third set of elements from a first end of the vector and a fourth set of elements from a second end of the vector.

14. The method of claim 8, wherein the first element and the second element are different elements in the vector.

15. A system comprising:
a set of processing units; and
a non-transitory machine-readable medium storing instructions that when executed by at least one processing unit in the set of processing units cause the at least one processing unit to:
use a window to select a first set of elements in a vector of elements;
select a first element from the first set of elements having the highest absolute value;
slide the window along the vector by a defined number of elements;
use the window to select a second set of elements in the vector, wherein the first set of elements and the second set of elements share at least one common element; and
select a second element from the second set of elements having the highest absolute value.

16. The system of claim 15, wherein the vector is a first vector, wherein the instructions further cause the at least one processing unit to multiply the selected first and second elements in the vector with corresponding first and second elements in a second vector of elements.

17. The system of claim 16, wherein the first and second vectors are parameters in a neural network model.

18. The system of claim 15, wherein the first element in the first set of elements is included in the second set of elements, wherein selecting the second element from the second set of elements comprises selecting an element other than the first element from the second set of elements having the highest absolute value.

19. The system of claim 15, wherein the program further comprises a set of instructions for, after selecting the first element from the first set of elements and before selecting the second element from the second set of elements, storing the first element and modifying the value of the first element in the vector to a defined value.

20. The system of claim 15, wherein the second set of elements comprises a third set of elements from a first end of the vector and a fourth set of elements from a second end of the vector.
